(19) United States
(12) Patent Application Publication
(10) Pub. No.: US 2007/0100115 A1
(43) Pub. Date: May 3, 2007

(54) Method for the production of powdered condensed resins

(75) Inventors: Markus Schmid, Deidesheim (DE); Marc Hahnlein, Mannheim (DE); Heinrich Sack, Hassloch (DE); Gunter Scherr, Ludwigshafen (DE); Marta Martin-Portugues, Ludwigshafen (DE)

Correspondence Address: CONNOLLY BOVE LODGE & HUTZ, LLP, P O BOX 2207, WILMINGTON, DE, 19899, US

(73) Assignee: BASF AKTIENGESELLSCHAFT, Ludwigshafen (DE)

(21) Appl. No.: 10/551,792

(22) PCT Filed: Mar. 24, 2004
(86) PCT No.: PCT/EP04/03104

§ 371 Date: Sep. 27, 2005

(30) Foreign Application Priority Data
Mar. 28, 2003 (DE) 103 14 466.8

(51) Int. Cl. C08G 8/02

(52) U.S. Cl. 528/128

(57) ABSTRACT

In a spray condensation process for the preparation of dried resins in powder form, the condensation of at least one crosslinkable starting material which is liquid or dissolved in a liquid phase with at least one aldehyde is carried out in a spray reactor.

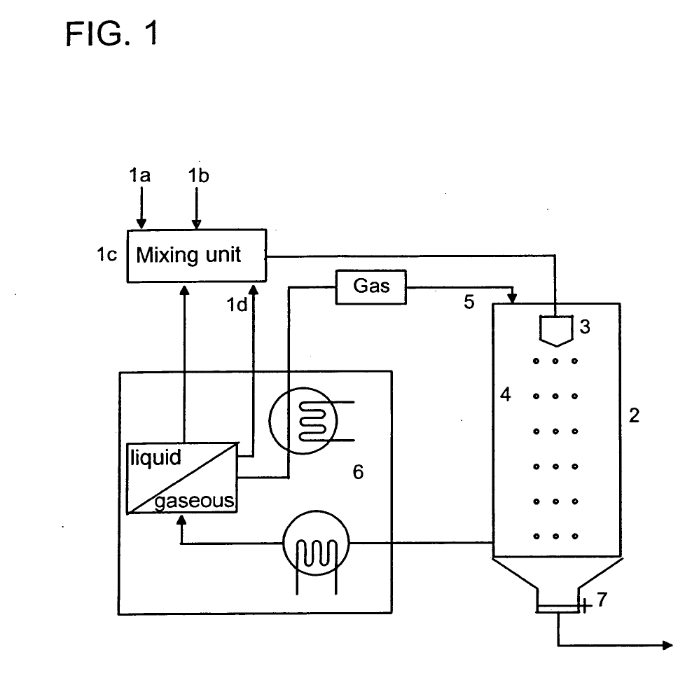

The present invention relates to a spray condensation process for the preparation of dried resins in powder form, the condensation of at least one starting material which is liquid or dissolved in a liquid phase with at least one aldehyde being carried out in a spray reactor.

The preparation of solid condensates in powder form from liquid or dissolved starting materials is now carried out on an industrial scale in multistage processes. The process step comprising the chemical reaction is effected predominantly in stirred kettles operated batchwise or continuously. The reaction product is then present in dissolved form and has to be brought into the desired form by energy-consumptive drying and comminution processes and the solvent has to be worked up. The drying process can, for example, be carried out in a spray tower. Spray-drying of reacted melamine/formaldehyde condensates is described, inter alia, in DE-B-2502168, DD 259 409 and GB 2 178 749. A major difficulty is associated with the handling of these highly viscous solutions or gels condensed in the stirred kettle. Compared with the solutions, powdered melamine/formaldehyde condensates have, inter alia, the advantage that they have a substantially longer shelf-life and that the transport of water during shipping is dispensed with.

DE-A-22 33 428 describes a process for encapsulating substances finely distributed in a reactive liquid, by the spray condensation method. During the spray condensation, the reactive system polymerizes with formation of capsule walls, and dry polymer capsules are obtained. Precondensates of urea or melamine formaldehyde compounds are mentioned as reactive system.

GB 949 968 describes a process for the preparation of organic polymeric material, the organic material or a suitable starting material being sprayed into hot gas whose temperature is sufficiently high to initialize foaming or expansion. It is disclosed that urea formaldehyde resins which are used as starting materials cure in this hot stream.

Spray polymerization reactions which combine the process of polymerization and drying in one process step have been known for some years and have been used for a wide range of polymerization reactions (inter alia WO 96/40427 and U.S. Pat. No. 5,269,980).

It is an object of the present invention to provide a simplified process for the preparation of condensed resins in powder form. Advantageously, the condensates can be prepared continuously in a few process steps. Furthermore, the condensates have a diameter of from 10 μm to 1 mm.

We have found that this object is achieved by a process for the preparation of condensed resins in powder form, in which the condensation of at least one crosslinkable starting material which is a liquid or dissolved in a liquid phase with at least one aldehyde is carried out in a spray reactor.

The disadvantages of a multistage condensation process can be eliminated in an elegant manner with the use of a spray condensation. The spray condensation is a continuous condensation process which, in comparison with solution condensation carried out in stirred kettles, permits the direct preparation of a dry product in particle form from starting materials which are liquid and/or dissolved in a liquid phase, in principle in a single process step. The condensation, including the precondensation, is combined with the basic operations of drying and mechanical comminution. Thus, the chemical reactions are combined with a plurality of basic process engineering operations to give a single continuous, one-stage process step.

The process comprises first mixing at least one condensable and crosslinkable substance with an aldehyde in, if required, a solvent and/or a transport gas. Suitable starting materials are preferably compounds which are capable of reacting with aldehydes and/or dialdehydes, e.g. glyoxal, particularly preferably with formaldehyde, in a polycondensation reaction to give resins. Preferably, those starting materials which may be used together with formaldehyde in the preparation of aminoplast resins are suitable (cf. Ullmanns Enzyklopädie der technischen Chemie, 4th Edition, Volume 7, pages 403 to 422), e.g. melamine, urea, dicyandiamide and guanamines, such as benzoguanamine and acetoguanamine, bisguanamines, such as adipo-, glutaro- or methylolglutarobisguanamine, compounds which contain a plurality of nuclei, e.g. fused aminotriazine nuclei, and 2-(5-hydroxy-3-oxapentylamino)-1,3,5-triazine, 2,4-di-(5-hydroxy-3-oxapentylamino)-1,3,5-triazine, 2,4,6-tris-(5-hydroxy-3-oxapentylamino)-1,3,5-triazine (THOM) or mixtures of these compounds (HOM), 2-(alkyl)-1,3,5-triazine, 2,4-di-(alkyl)-1,3,5-triazine, 2,4,6-tris-(alkyl)-1,3,5-triazine or mixtures of these compounds, where alkyl is C1- to C10-alkyl with or without branching. NH-comprising substances, such as substituted (e.g. alkylureas, phenylureas or acetylureas), cyclic (e.g. ethyleneureas) or polymeric ureas, and furthermore thiourea, urethanes, cyanamide, dicyanamide, guanidines, mono- and polyamines, such as polyalkylenamines, acid amides, such as those of formic acid, glycolic acid, lactic acid or the industrially customary unsaturated acids or sulfonic acids, and polyamides, amides and lactams, e.g. formamide, methylformamide, dimethylformamide, C3- to C9-lactams, ethanolamides, e.g. formic acid ethanolamide, acetic acid ethanolamide, trishydroxyethyl isocyanurate-hydroxyethylurea, the abovementioned compounds in ethoxylated form, these compounds carrying on average preferably from 1 to 20 ethylene oxide units, in particular including ethoxylated caprolactam, ethoxylated oligo-or polycaprolactam having on average from 1 to 10 ethylene oxides per caprolactam unit, and furthermore ethoxylated melamine, and moreover the elasticizers mentioned in EP-A-800543, are also suitable.

Phenol and other phenol derivatives, as described, for example, in Ullmanns Enzyklopädie der technischen Chemie (Phenolharze: 4th Edition, Volume 18, pages 245 to 257), are furthermore preferably suitable.

Particularly preferably, melamine, urea or mixtures thereof are reacted with an aldehyde, particularly with formaldehyde.

Melamine is usually used in solid form. The urea is used in solid or molten form or in the form of an aqueous solution. The formaldehyde is preferably used in the form of from 30 to 70% strength by weight aqueous solution or in the form of paraformaldehyde. All mixing ratios known to a person skilled in the art may be set. In particular, from 1.2 to 6 mol of aldehyde, preferably formaldehyde, is used per mol of melamine and from 1.3 to 3 mol of aldehyde, preferably formaldehyde, per mol of urea. If required, from 0.01 to 0.9, preferably from 0.01 to 0.5, in particular from 0.01 to 0.3, mol of one of the other compounds which are capable of reacting with aldehydes in a polycondensation reaction can be used per mol of melamine and/or urea.

The starting materials can, if required, be present in a solvent. The preferred solvent is water. The transport gas may be air or a conventional inert gas, such as nitrogen. If required, it is possible to use assistants and additives, such as
monohydric or polyhydric alcohols, e.g. methanol, ethanol, 1-propanol, 2-propanol, 1-butanol, 2-butanol, tert-butanol, ethylene glycol, diethylene glycol, triethylene glycol, polyethylene glycols, butanediols, pentanediols, hexanediols, trimethylolpropane, neopentylglycol and sorbitol
amino alcohols, e.g. ethanolamine, diethanolamine and triethanolamine.

The preparation of the reactive mixture may take place in a separate reactor, in a mixing zone upstream of the atomization or directly in the spray reactor.

The starting materials may be mixed at different pH values, and these depend on the starting materials. For the melamine/formaldehyde condensation, a pH of from 6.5 to 12 is preferred, whereas a pH of from 2 to 7.5 is advantageous for urea/formaldehyde condensation. The phenol/formaldehyde condensation can be carried out in the acidic, neutral or basic range.

In order to prevent premature condensation before spraying, the mixture can preferably be cooled, a temperature of from −40° C. to 30° C., in particular from −10° C. to 20° C., being preferred. The feed pipe to the spray reactor and the nozzles or atomizer disks can likewise be cooled in the case of extremely reactive starting materials. Furthermore, in order to prevent undesired precondensation, on the one hand the pressure in the pipes can be increased and on the other hand, if required, any additives and/or catalysts which initiate the condensation can be added only shortly upstream of the spray reactor.

For practical reasons, it may be advantageous not to atomize a reactive mixture as such but to produce it in situ by spraying two or more reactants into one another in the reactor itself. This may be necessary especially in the case of particularly fast reaction mixtures, in order to avoid blockages in the transport and mixing zone or in the atomization apparatus.

A liquid reaction solution which may comprise one or more starting materials and, if required, solvent and further assistants, is atomized in a reactor. The reactor used is a spray reactor known to a person skilled in the art, preferably a spray tower. For example, this has a height of, typically, from 10 to 20, preferably from 12 to 17, meters and a customary diameter of, typically, from 2 to 10, preferably from 4 to 7, meters. The reactor may consist of a plurality of reactor sections, the upper part in which the nozzle arrangement is present preferably being cylindrical, while the lower part may be conical. The conical region is preferably greater than the cylindrical one.

The atomization can be effected by means of one or more nozzles or by means of atomizer disks. The nozzles are usually provided in the upper part of the reactor. The nozzles have a typical diameter of from 1 μm to 10 mm, preferably from 500 μm to 3 mm. The spray nozzles are usually arranged in an annular manner in the reactor tower, i.e. they are preferably arranged symmetrically and uniformly distributed over the cross section, and are preferably supplied via a common ring pipe with the liquid to be sprayed. On an industrial scale, the number of spray nozzles per ring pipe is typically from 5 to 50, frequently from 10 to 30. In general, up to 20 such nozzle rings are used. It is preferable according to the invention if the spray cones of a spray nozzle overlap horizontally and vertically so that the total volume can be homogeneously treated with spray droplets. All nozzles known to a person skilled in the art can be used as atomizer nozzles. Solid-cone spray nozzles having an opening angle of the spray cone in the range from 60° to 180°, preferably from 90° to 120°, are preferred according to the invention. On an industrial scale, the throughput per spray nozzle is typically up to 1 500, preferably from 1 to 500, in particular from 100 to 125, kg/h.

The atomization of the mixture results in the formation of drops having a very uniform, controllable size. The drops condense on falling. The atomization makes it possible to establish drops having a very small size, typically a mean diameter of from 1 μm to 2 mm, preferably from 10 μm to 1 mm, particularly preferably from 30 to 500 μm, in particular from 50 to 300 μm. The diameter of the drops can be varied by means of the diameter of the nozzle orifice or by means of the diameter of the holes in the atomizer disks; furthermore, the size of the drops can be established by means of the pressure of the mixture of starting materials.

The pressure prior to spraying can be adjusted within a wide range. The spraying can be carried out at atmospheric pressure, but a superatmospheric pressure of, for example, from 60 to 100 bar can also be established.

Excessively large drops tend to fragment through shear forces; moreover, the residence time of large drops is very short, and incomplete condensation may be the result.

The drops are present for a certain time in the reaction atmosphere, and this residence time is dependent on the drop size and on the reaction conditions. The residence time is adapted to the respective condensation conditions and the desired end product, i.e. it must be sufficiently long to enable the desired degree of condensation to be reached. The reaction rate is thus of the order of magnitude of the rate of the vaporization process and the residence time in the reactor. The residence time is preferably from 5 to 150, particularly preferably from 90 to 120, seconds. The atomized reaction mixture can fall downward in the reactor with or without gas flow or can be driven upward by a flow against the force of gravity. By suitable process engineering measures, for example electrostatic forces, drops can also be moved sideways with reduced falling or buoyancy movement or can be kept completely in suspension in order to achieve an arbitrarily long residence time. Preferably, the propellant flows in the direction of fall. The solvent is preferably vaporized continuously during the reaction process and evacuated from the reactor.

Air, stack gas or any known inert gas may be used as propellant or as accompanying gas. For practical reasons, it is preferable to use dry air, which is typically heated to a temperature of from 100 to 200° C., preferably from 140 to 180° C., before the reactor entrance. Usually, condensation is effected at atmospheric pressure. The propellant ensures that no bond is formed between the gas and the droplet material. The propellant advantageously also serves for discharging the uncondensed starting materials. The heat of reaction is withdrawn from the solvent/starting material/propellant mixture after discharge, preferably by cooling. For example, the gaseous fraction is separated from the liquid fraction by means of a cold trap. The liquid fraction consists of the solvent and the starting material and can be fed to the reaction mixture. The propellant recovered can be reused in the spray reactor. A second variant comprises using only fresh propellant without purifying the resulting solvent/starting material/inert gas mixture.

The external parameters in the spray reactor, such as pressure and temperature, are variable within the ranges expedient in terms of process engineering. The pressure is preferably from 0.001 to 20, in particular from 0.1 to 10, bar. However, it may be advantageous in some applications to operate at reduced pressure, which is from 1 to 10, preferably from 2 to 5, mbar. The temperature is preferably from 0 to 300° C., in particular from 20 to 150° C.

In the case of some applications, a spray tower operated in a steady state may be advantageous, in which case the inert gas does not flow through the reactor but is fed into the upper part of the reactor and thus flows only past the nozzles in order to discharge the evaporating solvent and possible uncondensed starting materials at the place of formation of the drops.

Usually, the temperature in the spray reactor is constant, but a temperature profile may also be advantageous in some condensations. In particular, the reaction can also be carried out at reduced or superatmospheric pressure. Moistening of the gas, i.e. loading of the gas phase with water or other solvents, can be used for controlling the material transport. In particular, a small vapor pressure difference can be established at the phase boundary of the drops with the environment by vaporizing unreacted starting material. Furthermore, the spray reactor may be composed of segments in which in each case different operating conditions can prevail.

By the external action of energy, for example in the form of elevated temperatures, on the reaction mixture, mass transport of reactive substances into said mixture or chemical reaction of the atomized mixture which may itself be reactive, a chemical transformation within the drops is initiated. This can alternatively also be effected by using any desired combination of these processes. In the overall balance of the process, the chemical reaction can consume energy or, for example in the case of exothermic reactions, also release energy. Because of the intensive energy, mass and momentum exchange between the continuous, gaseous phase and the reactive drops and owing to the substance transformation within the drops which is coupled with an energy transformation, phase transformation processes, such as crystallization and vaporization, are initiated.

The products of the spray process are generally solid particles which can be deposited from the gas phase and finally obtained in powder form. Preferably, the product is obtained in dry powder form. Here, the term dry powder form describes particles which no longer agglomerate or adhere and have a residual moisture content of from 0.5 to 3%, preferably less than 1%. The dry condensates, including precondensates, typically have a diameter of from 1 μm to 2 mm, preferably from 10 μm to 1 mm, particularly preferably from 30 to 500 μm, in particular from 50 to 300 μm.

The powder can be discharged by a method known to a person skilled in the art from the spray reactor without changing its reaction atmosphere. For example, the discharge is effected by means of blade units. Advantageously, the product obtained is separated from the resulting fine dust by means of filtration.

The spray condensation process can on the other hand also be carried out in such a way that, as a result of unconverted starting material or incompletely vaporized solvent, a liquid product or a solid product laden with residual moisture is obtained. At the exit of the spray reactor, a moist (intermediate) product can be passed into a downstream reactor in which the desired final conversion, the drying or a physical or chemical modification of the product is then carried out.

The energy liberated in exothermic condensation reactions in the overall energy balance of the spray condensation process substantially in the form of hot vapor (e.g. steam) and elevated reactor temperature can be utilized and can thus contribute substantially to the cost-efficiency of the process.

Furthermore, this invention relates to dry condensed resins in powder form. The product morphology of the condensed resins, i.e. structure, size and density, are uniform and directly controllable via the reaction conditions in the spray tower.

The melamine, urea or phenol resins or mixtures thereof prepared by the novel spray condensation process are available for all uses known to a person skilled in the art, in particular as glues, impregnating resins, for impregnating decorative or overlay papers, for coating wood-based materials and for impregnating open textile fabrics and/or nonwoven textiles for further processing to shaped articles.

Furthermore, the novel process can be used for preparing resins which are cured in a single process step and, for example, are used as organic pigments and fillers.

The novel process has the advantage that resin powders can be obtained in a single process step in a spray reactor directly from starting materials. Accordingly, the disadvantages of a multistage process of the prior art were overcome and in particular it was possible to solve the problems which arise from a batchwise multistage condensation and drying process.

The invention is explained in more detail below with reference to the FIGURE and on the basis of a working example:

In a mixing vessel (1) (volume 1 500 l) having a mechanical stirrer, 392 kg of urea were dissolved in 540 kg of an aqueous 49% strength formaldehyde solution brought to pH 8 with sodium hydroxide solution (1% in water). The molar ratio of formaldehyde to urea was brought to 1.35. The vessel was thermostated at 0° C. The solution was colorless and clear and had a low viscosity.

The solution of urea and formaldehyde (feed 1a) was brought to pH 4 with 25% strength formic acid (feed 1b) in a mixing unit.

The mixture was sprayed by means of nitrogen via a feed (1d) through 10 nozzles (3) having a diameter of 1 mm into a heated spray reactor (2) (about 170° C., 5 mbar reduced pressure relative to the atmosphere, nitrogen atmosphere, reactor height: 12 m, reactor diameter: 6 m). The metered stream of the reaction mixture was 1 000 kg/h and the atomizing nitrogen stream was 20 000 m³/h. The residence time was 1 minute. The drops (4) had a diameter distribution of 30-400 μm (volume average 160 μm). The condensate was separated off at the tower exit (7) by means of a filter. The solvent and uncondensed starting materials were discharged from the reactor by means of nitrogen. The solvent/starting material/nitrogen mixture was cooled in (6) and purified by means of a gas scrubber, and the nitrogen was used again (5) in the spray reactor. Thus, 590 kg of white, flowable powder were obtained (89% yield). The particle size was determined according to DIN 66165 and was 120 μm. The residual moisture content of <1.5% by weight was determined by drying the sample for 6 minutes at 90° C.

1. A process for the preparation of condensed resins in powder form, wherein the condensation of at least one crosslinkable starting material which is liquid or dissolved in a liquid phase with at least one aldehyde is carried out in a spray reactor.

2. The process according to claim 1, wherein the condensation is carried out at from 20 to 150° C.

3. The process according to claim 1, wherein the starting materials are introduced into the reactor by at least one nozzle having a diameter of from 1 μm to 10 mm.

4. The process according to claim 1, wherein the condensation is carried out in individual drops.

5. The process according to claim 1, wherein the condensation is carried out in the presence of a dry accompanying gas.

6. The process according to claim 1, wherein the condensation is carried out at from 0.001 to 20 bar.

7. The process according to claim 1, wherein the condensation is carried out at from 2 to 5 mbar.

8. The process according to claim 1, wherein condensates having a mean particle diameter of from 10 μm to 1 mm are prepared.

9. The process according to claim 1, wherein condensates having a mean particle diameter of from 50 μm to 300 μm are prepared.

10. The process according to claim 1, wherein the starting materials, which may be present in a solvent, are mixed prior to spraying and are kept at from −40 to +30° C.

11. The process according to claim 1, wherein the starting material used is melanine, urea, or a mixture thereof.

12. The process according to claim 1, wherein the aldehyde used is formaldehyde.

13. A condensate obtainable by the process according to claim 1.

14. A condensate obtainable by the process according to claim 1, which has a moisture content of from 0.5 to 3%

15. The process according to claim 2, wherein the starting materials are introduced into the reactor by at least one nozzle having a diameter of from 1 μm to 10 mm.

16. The process according to claim 2, wherein the condensation is carried out in individual drops.

17. The process according to claim 3, wherein the condensation is carried out in individual drops.

18. The process according to claim 2, wherein the condensation is carried out in the presence of a dry accompanying gas.

19. The process according to claim 3, wherein the condensation is carried out in the presence of a dry accompanying gas.

20. The process according to claim 4, wherein the condensation is carried out in the presence of a dry accompanying gas.
